(19) United States
(12) Patent Application Publication
(10) Pub. No.: US 2009/0037968 A1
(43) Pub. Date: Feb. 5, 2009

(54) USING LAYERED MULTI-STREAM VIDEO CODING TO PROVIDE INCENTIVES IN P2P LIVE STREAMING

(76) Inventors: Zhengye Liu, Brooklyn, NY (US); Shivendra S. Panwar, Freehold, NJ (US); Keith W. Ross, NY, NY (US); Yanming Shen, Brooklyn, NY (US); Yao Wang, Livingston, NJ (US)

Correspondence Address: STRAUB & POKOTYLO, 788 Shrewsbury Avenue, TINTON FALLS, NJ, 07724, US

(21) Appl. No.: 12/146,374

(22) Filed: Jun. 25, 2008

Related U.S. Application Data
(60) Provisional application No. 60/937,807, filed on Jun. 28, 2007.
(60) Provisional application No. 61/075,248, filed on Jun. 24, 2008.

(51) Int. Cl. H04N 7/173

(52) U.S. Cl. 725/114

(57) ABSTRACT

A distributed incentive mechanism is provided for peer-to-peer (P2P) streaming networks, such as mesh-pull P2P live streaming networks. Video (or audio) may be encoded into multiple sub-streams such as layered coding and multiple description coding. The system is heterogeneous with peers having different uplink bandwidths. Peers that upload more data (to a peer) receive more substreams (from that peer) and consequently better video quality. Unlike previous approaches in which each peer receives the same video quality no matter how much bandwidth it contributes to the system, differentiated video quality, commensurate with a peer's contribution to other peers, is provided, thereby discouraging free-riders.

### § 0.1 RELATED APPLICATIONS

Benefit is claimed to the filing date of both: U.S. Provisional Patent Application Ser. No. 60/937,807 (“the '807 provisional”), titled “USING MULTI-STREAM CODING IN P2P LIVE STREAMING,” filed on Jun. 28, 2007 and listing Zhengye LIU, Shivendra S. PANWAR, Keith W. ROSS, Yanming SHEN and Yao WANG as inventors; and U.S. Provisional Patent Application Ser. No. 61/075,248 (“the '248 provisional”), titled “SUBSTREAM TRADING: TOWARDS AN OPEN P2P LIVE STREAMING SYSTEM,” filed on Jun. 24, 2008 and listing Zhengye LIU, Shivendra S. PANWAR, Keith W. ROSS, Yanming SHEN and Yao WANG as inventors. The '807 and '248 provisionals are incorporated herein by reference. However, the scope of the claimed invention is not limited by any requirements of any specific embodiments described in the '807 and the '248 provisionals.

### § 0.0 GOVERNMENT RIGHTS

The United States Government may have certain rights in this invention pursuant to a grant awarded by the National Science Foundation. Specifically, the United States Government has a paid-up license in this invention and the right in limited circumstances to require the patent owner to license others on reasonable terms as provided for by the terms of Contract or Grant No. 0435228 awarded by the National Science Foundation.

### § 1. BACKGROUND OF THE INVENTION

§ 1.1 Field of the Invention

The present invention concerns the live streaming of coded information. More specifically, the present invention concerns providing incentives in peer-to-peer (“P2P”) video live streaming.

§ 1.2 Related Art

With the widespread adoption of broadband residential access, P2P video live streaming has become a popular service in the Internet. Several streaming systems have been successfully deployed, serving tens of thousands of simultaneous users who watch channels at rates between 300 kbps to 1 Mbps. (See, e.g., “PPLive.” [Online]. Available: http://www.pplive.com/; “PPStream.” [Online]. Available: http://www.ppstream.com/; X. Zhang, J. Liu, B. Li, and P. Yum, “DONet: A data-driven overlay network for efficient live media streaming,” Proc. of IEEE INFOCOM (2005); “UUsee.” [Online]. Available: http://www.uusee.com/; and X. Hei, C. Liang, J. Liang, Y. Liu, and K. W. Ross, “A measurement study of a large-Scale P2P IPTV system,” IEEE Trans. on Multimedia, to appear. Existing systems use single-stream encoding and mesh-pull design.

In these existing live streaming systems, free-riding is a potential problem, similar to what has been observed in P2P file sharing systems. (See, e.g., P. Colle, K. Leyton-Brown, and I. Mironov, “Incentives for sharing in peer-to-peer networks,” ACM Conference on Electronic Commerce (2001). The present inventors believe that the problem of free-riders is primarily due to the fact that the existing systems provide the same video quality to all peers, no matter what their individual upload contributions are. However, in many P2P streaming systems, participating peers will have different upload bandwidths. For example, institutional peers might have high-bandwidth access, while residential peers with DSL and cable access will have relatively low upload bandwidth.

An efficient incentive mechanism helps the performance of a P2P system. For example, BitTorrent (See, e.g., “BitTorrent.” [Online]. Available: http://www.bittorrent.com/.), one of the most popular P2P file downloading system, largely solves the incentive problem by adopting a tit-for-tat strategy. (See, e.g., B. Cohen, “Incentives build robustness in BitTorrent,” 1st Workshop on Economics of Peer-to-Peer Systems, (June 2003).) However, in file downloading systems such as BitTorrent, the primary performance measure is download time. Designing incentive mechanisms for live video streaming is more challenging than for traditional file downloading.

In view of the foregoing, it would be useful to avoid free-riding in P2P live streaming systems.

### § 2. SUMMARY OF THE INVENTION

At least some embodiments consistent with the present invention use multiple sub-streams (referred to as multi-stream coding) in a P2P live streaming system. With multi-stream coding, a video is coded into multiple layers (or more generally, substreams), where more received layers (or more generally, substreams) provide better video quality. At least some embodiments consistent with the present invention perform a distributed incentive strategy in which each peer (1) measures its download rates from its neighbors, and (2) reciprocates by providing a larger fraction of its upload rate to the neighbors from which it is downloading at higher rates. Consequently, a peer with a higher upload contribution is more likely to obtain a larger share of neighbors' upload rates, thus receiving more layers (or more generally, substreams), which in turn provides better video quality. Conversely, a peer with a lower upload contribution is more likely to receive less layers (or more generally, substreams), which in turn provides a lower (but perhaps still acceptable) video quality. A free-rider with no contribution to its neighbors is less likely to be served by its neighbors. The peers may evaluate their neighbors' upload contributions in a distributed manner.

At least some embodiments consistent with the present invention use layered multi-stream coding (though other multi-stream coding schemes such as multiple description coding (“MDC”) may be used instead). With layered video coding, video is coded into layers with nested dependency such that a higher layer refines the video generated by lower layers. A higher layer can be decoded only if all the lower layers are available. Consequently, more layers provide better video quality. With MDC, a video is encoded into several descriptions with equal importance. When a video is encoded into M descriptions, the combination of any m≦M different descriptions is decodable, with more descriptions introducing a better video quality.

### § 3. BRIEF DESCRIPTION OF THE DRAWINGS

FIG. 1 illustrates an environment in which embodiments consistent with the present invention may be used.

FIG. 2 is a bubble diagram of operations that may be performed, and information that may be used and/or generated by such operations, in a manner consistent with the present invention, combined with an illustration of exemplary messaging.

FIG. 3 is a flow diagram of an exemplary method for serving layered video information to receiving peers in a manner consistent with the present invention.

FIG. 4 is a flow diagram of an exemplary method for supplying layered video information in a manner consistent with the present invention.

FIG. 5 is a flow diagram of an exemplary method for performing supplier-side scheduling in a manner consistent with the present invention.

FIG. 6 is a flow diagram of an exemplary method for performing receiver-side scheduling in a manner consistent with the present invention.

FIGS. 7A and 7B illustrate exemplary buffer state information used to illustrate receiver-side scheduling consistent with the present invention.

FIG. 8 is a block diagram of exemplary apparatus that may be used to perform operations in a manner consistent with the present invention, and/or to store information, in a manner consistent with the present invention.

FIG. 9 illustrates exemplary request queue used to illustrate a download rate probing operation consistent with the present invention.

FIG. 10 is an example illustrating how an exemplary random request technique consistent with the present invention requests layer chunks from neighbors.

### § 4. DETAILED DESCRIPTION

An exemplary environment in which embodiments consistent with the present invention may be used is introduced in § 4.1. Then, exemplary methods for performing operations consistent with the present invention are described in § 4.2. Next, exemplary apparatus for performing various operations and generating and/or storing various information in a manner consistent with the present invention are described in § 4.3. Refinements, alternatives and extensions are described in § 4.4. Finally, some conclusions about such exemplary embodiments are provided in § 4.5.

### § 4.1 EXEMPLARY ENVIRONMENT IN WHICH EMBODIMENTS CONSISTENT WITH THE PRESENT INVENTION MAY BE USED

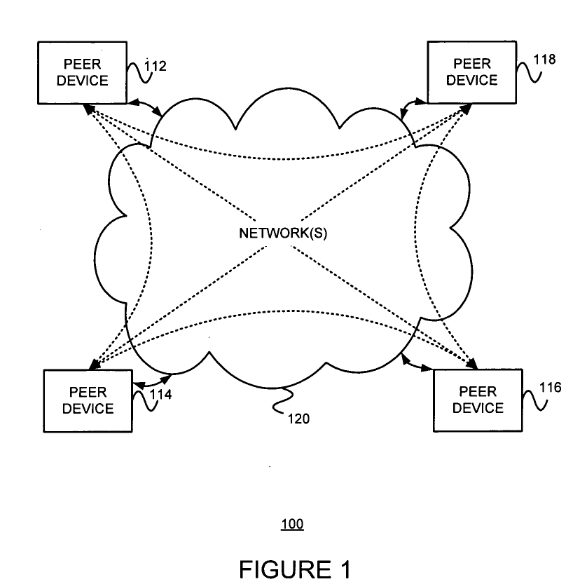

FIG. 1 illustrates an environment 100 in which embodiments consistent with the present invention may be used. Peer devices 112, 114, 116 and 118 can communicate with one another via one or more network(s) 120 such as the Internet for example. As indicated by the dashed lines, each of the peers may establish a communications session with the other peers thereby establishing a full-mesh topology. The peer devices may (1) encode and stream video information (or simply stream previously encoded video information), (2) decode (and play) video information, or (3) both. Peer devices may include any device that may perform one or both of the foregoing functions. Thus, peer devices may include desktop computers, laptop computers, smart phones, personal digital assistants (“PDAs”), video players, set-top boxes, etc.

Embodiments consistent with the present invention may be used in the context of a mesh-pull delivery architecture.

Embodiments consistent with the present invention may use multi-stream coded video. MDC and layered coding are two examples of multi-stream coding. Each is introduced below.

With MDC, a video is encoded into several descriptions with equal importance. When a video is encoded into M descriptions, the combinations of any m≦M different descriptions are decodable, with more descriptions introducing a better video quality. Although MDC simplifies the system design, the redundancy significantly reduces the video coding efficiency (with the existing MDC coders). Consequently, with the same transmission bit rates, the video quality of MDC is much lower than that of a single layer coded video or a layered video.

Unlike MDC, with layered coding, a video is encoded into several layers with nested dependence. A higher layer can be decoded only if all the lower layers are available. Generally, layered coding does not lose much video coding efficiency compared with single layer coding. Layered coding in P2P video streaming has some challenges. For example, since the different layers have unequal importance due to the nested dependence of layers, scheduling algorithms should assign higher priorities to lower layers than higher layers. Second, a peer with a higher contribution should receive more layers than a peer with a lower contribution. However, it is possible that no neighbor of a peer holds the higher layers desired. In this case, to obtain the layers commensurate with its upload contribution, a high-bandwidth peer should be able to locate other high-bandwidth peers that have higher layers.

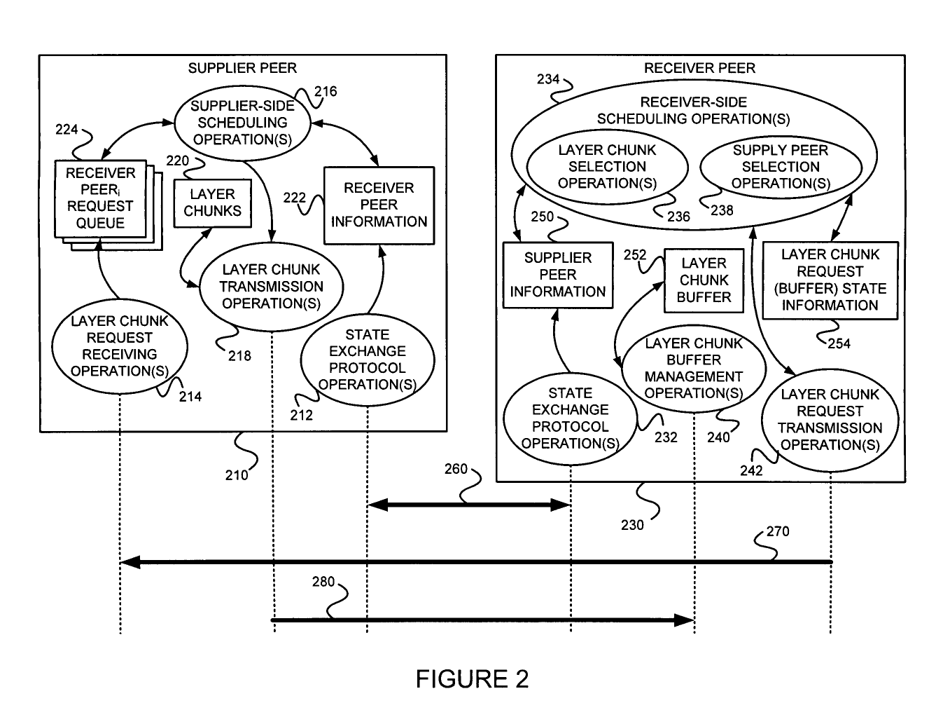

FIG. 2 is a bubble diagram of operations that may be performed, and information that may be used and/or generated by such operations, in a manner consistent with the present invention, combined with an illustration of exemplary messaging. Although peers may act as both a supplier of video information and a receiver of video information, FIG. 2 is described in the context of a supplier peer 210 and a receiver peer 230 for simplicity.

Supplier peer 210 includes state exchange protocol operation(s) 212, layer chunk request receiving operation(s) 214, supplier-side scheduling operation(s) 216, layer chunk transmission operation(s) 218, stored layer chunks 220, stored receiver peer information 222 and stored receiver peer request queues 224. Receiver peer 230 includes state exchange protocol operation(s) 232, receiver-side scheduling operation(s) 234 (which may include layer chunk selection operation(s) 236 and supply peer selection operation(s) 238), layer chunk buffer management operation(s) 240, layer chunk request transmission operation(s) 242, stored supplier peer information 250, stored layer chunk buffer 252 and stored layer chunk request (buffer) state information 254.

A video may be divided into media chunks, and the chunks may be made available at an origin server (not shown). For example, the origin server encodes a video into L layers (or more generally, substreams). Each layer (or more generally, substream) is further divided into Layer (or Substream) Chunks (“LCs”) of Δ seconds. If MD coding is used, description chunks (“DCs”) of Δ seconds may be generated instead.

When a (receiver) peer 230 wants to view the video, it may obtain a list of peers currently receiving the video and establish partnerships with several peers. Peers may exchange chunk availability information with their neighbors and request chunks that they need. For example, state exchange protocol operation(s) 212 and 232 may be used to exchange such information as indicated by communications 260. This information may be stored as receiver peer information 222 and/or supplier peer information 250.

Partner peers may then exchange LCs with each other during a discovery (e.g., an initial) period. During the discovery period, the peers may exchange LCs at an unconstrained rate (or attempt to do so). Each peer may measure its download rates from its neighbors. A peer reciprocates to its neighbors by providing a larger fraction of its upload rate to the neighbors from which it is downloading at the highest rates. In this manner, a peer with higher upload contribution is likely to be rewarded with more LCs, and hence more layers (or descriptions, or more generally, substreams) and better quality.

Referring to FIG. 2, the foregoing may be performed using both supplier-side scheduling and receiver-side scheduling. Supplier peer 210 may store layer chunks 220 to be served to one or more receiver peers. Layer chunk request receiving operation(s) 214 may (1) receive LC request(s) 270 from multiple neighbors (acting as receiver peers 230) and (2) store the LC requests in a corresponding request queue 224 for each receiver peer. The supplier peer 210 may use supplier-side scheduling operation(s) 216 to determine which LC request (which identifies a particular LC and a particular peer) should be served in a particular (e.g., present) time period (referred to as a “chunk time”) and how to allocate its available uplink bandwidth to its neighbors. The supplier-side scheduling operations 216 may use receiver peer information (e.g., measured download rates) 222 to make this determination. Finally, layer chunk transmission operation(s) 218 may transmit the LC (from storage 220), determined by the supplier-side scheduling operation(s) 216, to the receiver peer 230 that requested it, as indicated by communication 280.

The receiver peer 230 may prioritize its requests for missing but needed LCs. For example, using layer chunk request state information 254 (and supplier peer information 250), the receiver-side scheduling operation(s) 234 can generate layer chunk requests to be transmitted by layer chunk request transmission operation(s) 242. More specifically, layer chunk selection operation(s) 236 may determine a layer chunk to request, and supply peer selection operation(s) 238 may determine a peer from which to submit its request for the layer chunk. The LC request is transmitted to the selected supplier peer as indicated by communication 270.

Various exemplary methods that may be used to perform at least some of the foregoing operations are described in § 4.2 below.

### § 4.2 EXEMPLARY METHODS

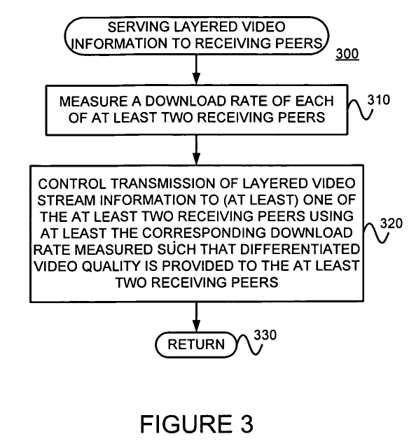

FIG. 3 is a flow diagram of an exemplary method 300 for serving layered video information to receiving peers in a manner consistent with the present invention. A download rate of each of at least two receiving peers is measured. (Block 310) Then, transmission of layered video stream information to (at least) one of the at least two receiving peers is controlled using at least the corresponding download rate measured such that differentiated video quality is provided to the at least two receiving peers. (Block 320) The method 300 is then left. (Node 330)

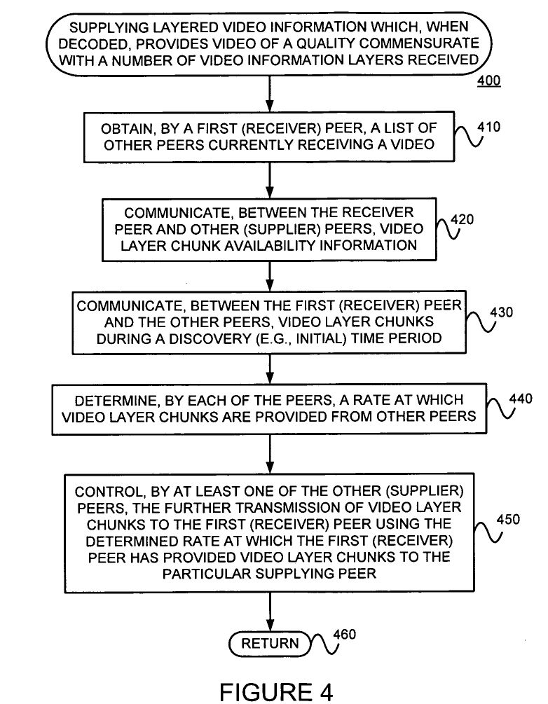

FIG. 4 is a flow diagram of an exemplary method 400 for supplying layered video information in a manner consistent with the present invention. A first (receiver) peer obtains a list of other peers currently receiving a video. (Block 410) The first peer and the other peers then communicate (e.g., exchange) video layer chunk availability information. (Block 420) The first peer and the other peers also communicate (exchange) video layer chunks during a discovery (e.g., an initial) period. (Block 430) Each of the peers determines a rate at which video layer chunks are provided from other peers. (Block 440) The further transmission of video layer chunks to the first (receiver) peer is controlled using the determined rate at which the first (receiver) peer has provided video layer chunks to the supplier peer. (Block 450) The method 400 is then left. (Node 460)

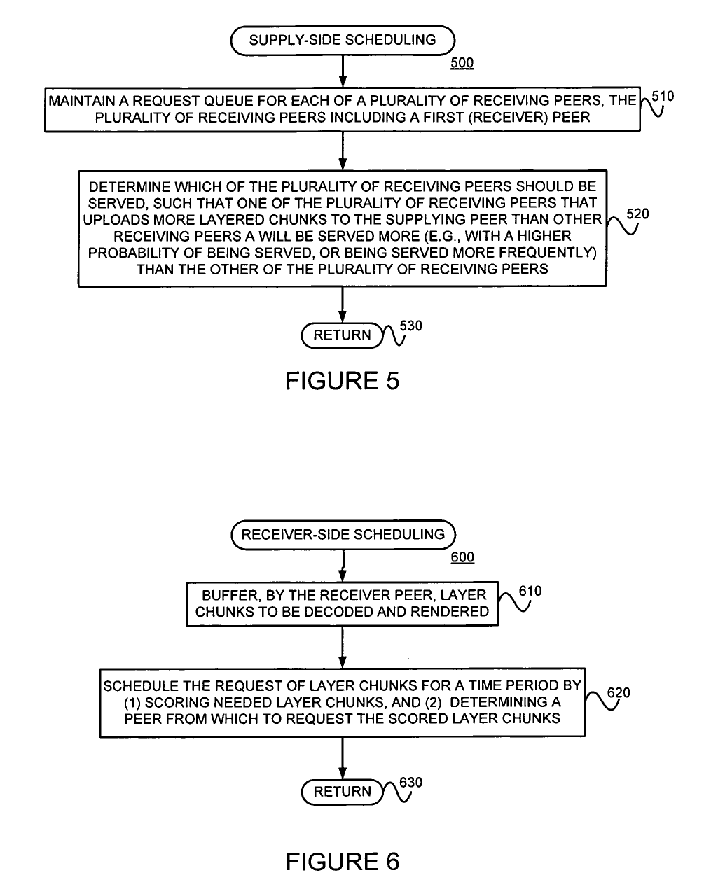

FIG. 5 is a flow diagram of an exemplary method 500 for performing supplier-side scheduling in a manner consistent with the present invention. A request queue for each of a plurality of receiving peers is maintained. (Block 510) It is then determined which of the plurality of receiving peers should be served, such that one of the plurality of receiving peers that uploads more layered chunks to the supplying peer than the other receiving peer(s) will be served more (e.g., with a higher probability of being served, or being served more frequently) than the other receiving peer(s). (Block 520) The method 500 is then left. (Node 530)

As can be appreciated from the foregoing, in at least some embodiments consistent with the present invention, a peer uploads more to the neighbors from which it downloads more. To this end, a supplier may maintain a different request queue for each receiver. (Recall, e.g., 224 of FIG. 2.) For a particular receiver, the queue may be first-in-first-out (“FIFO”) such that the supplier peer serves the requests in the order that the requests were received. The supplier peer may transmit one requested layer chunk (or description chunk, or more generally, substream chunk) to one receiver at one time.

Referring again to the supplier-side scheduling operation(s) 216 of FIG. 2, the supplier peer may determine which receiver peer should be served depending on the receiver peer's contribution to the supplier peer. In at least some embodiments consistent with the present invention, this may be done as follows. At any one time, the supplier peer randomly selects a receiver peer to serve. Let p_{n,k} denote the probability that peer n selects the receiver k. This probability p_{n,k} may be determined as follows:

$${p}_{n , k} = \frac{{I}_{n , k} {d}_{n , k}^{γ}}{{\sum }_{i ∈ {K}_{n}} {I}_{n , i} {d}_{n , i}^{γ}} , \qquad ( 1 )$$

where Kₙ denotes the set including all neighbors of peer n, and d_{n,i} is the estimated download rate of supplier peer n from receiver peer i. This estimated download rate d_{n,i} can be obtained based on the number of LCs delivered from peer i to peer n during the previous discovery time period. The value I_{n,i} equals 0 if the request queue of receiver peer i is empty, and equals 1 otherwise. The value γ is a parameter that controls the sensitivity of peer n to peer k's contribution. Therefore, a supplier peer in this example serves its neighbors in a weighted fashion, and a receiver peer that uploads more to the supplier has a higher probability of being served, thereby consuming a larger share of the supplier's uplink bandwidth.

FIG. 6 is a flow diagram of an exemplary method 600 for performing receiver-side scheduling in a manner consistent with the present invention. The receiver peer buffers layer chunks to be decoded and rendered. (Block 610) The request of layer chunks for a time period is then scheduled by scoring needed layer chunks, and determining a peer from which to request the scored layer chunks. (Block 620) The method 600 is then left. (Node 630)

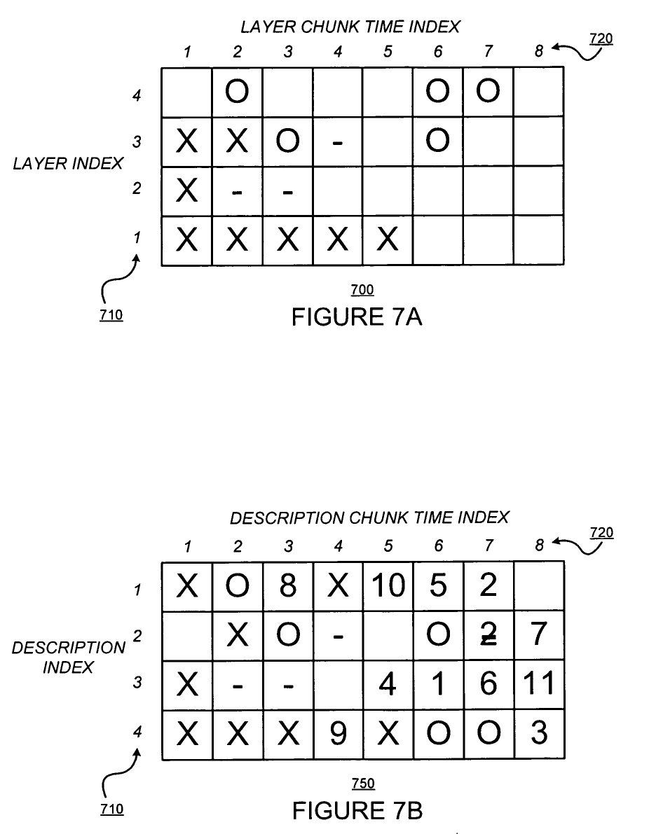

Referring again to the receiver-side scheduling operation(s) 234 of FIG. 2, at any given time, a receiver may buffer layer chunks (Recall 252 of FIG. 2.) that are to be displayed or otherwise rendered in the future. FIG. 7A illustrates exemplary buffer state information for the layer chunks buffered at a particular receiver peer, where the X's denote buffered layer chunks. In this example, there are eight (8) layer chunks buffered—three (3) for the next chunk time, two (2) for the second chunk time, and one (1) for each of the third, fourth and fifth chunk times. The dashes in FIG. 7A denote other layer chunks that have been requested, but have not yet arrived (or that have not yet been buffered). In this example, there are three such requested layer chunks. There are also layer chunks available in the neighbors, but have not been requested. These layer chunks are left blank in FIG. 7A. Additionally, some non-buffered layer chunks might not be available from any of the neighboring peers. These are shown by circles in FIG. 7A. Collectively, these buffered layer chunks (X), requested layer chunks (−), available layer chunks ( ), and unavailable layer chunks (O) constitute the current buffer state of the receiver peer.

In at least some embodiments consistent with the present invention, receiver peers request layer chunks at the beginnings of “rounds.” At the beginning of each round, the receiver peer has a buffer state, as described above. Given this buffer state, the receiver peer decides which layer chunks to request. The receiver peer may request layer chunks from the current time up until a window of B chunk times into the future. FIG. 7A illustrates a buffer state with a window of B=8.

Normally, at the beginning of each round, there are several available, but not requested layer chunks. The receiver-side scheduling operations may be used to determine (1) which layer chunk should be requested first (Recall, e.g., layered chunk selection operation(s) 236 of FIG. 2.) and (2) from which neighbor peer should it be requested (Recall, e.g., supply peer selection operation(s) 238.). Exemplary embodiments consistent with the present invention for making these determinations are described below.

In at least some exemplary embodiments consistent with the present invention, used in a system using layered coding, a score is assigned to each available but not requested Layer Chunk (LC). Layer chunks with lower scores get requested with higher priority. Three factors of a LC may be jointly considered to calculate the score. These factors may include (i) layer index of the layer chunk, (ii) playback deadline of the layer chunk, and (iii) rarity of the layer chunk among the receiver's peers. Alternatively, one or two of these factors may be considered rather than all three. Indeed, other factors may be considered instead of, or in addition to, any of these three factors.

With layered coding, since a layer can be decoded only if all the lower layers have been received, lower-layer layer chunks should be given higher priority. Also, a layer chunk in danger of being delayed beyond the playback deadline should be given a higher priority. Additionally, rare chunks should be given higher priority. Generally, for a peer n, the score S_{l,t}ⁿ of a layer chunk with layer index l and playback deadline t can be expressed as:

S_{l,t}ⁿ=G=(l,t,λ) (2)

where λ is the number of duplicates of this layer chunk available in the neighbors of peer n. G(.) may be a monotonously increasing function with l, t and λ. For example, a weighted linear combination of these three factors, mathematically expressed as:

$${S}_{l , t}^{n} = {w}_{1} \frac{l}{L} + {w}_{2} \frac{t - {t}_{0}}{B} + {w}_{3} \frac{λ}{K} \qquad ( 3 )$$

where t₀ is the current time, L is the total number of layers, B is the buffer size in terms of LC times, and K is the number of neighbors of peer n, may be used. w₁, w₂ and w₃ are weights of the three factors.

A receiver peer requests the available but not requested layer chunks from the lowest score to the highest score. Given a layer chunk, a receiver peer n can estimate the time τ_{n,k} that this layer chunk is to be received from its neighbor peer k by the following equation:

$${τ}_{n , k} = {t}_{0} + {C}_{n , k} \frac{r Δ}{{d}_{n , k}} , \qquad ( 4 )$$

where C_{n,k} is the number of outstanding requests from n to k, r is the bit rate of one layer, and d_{n,k} is the estimated download rate of peer n from peer k. In the exemplary heuristic of layered coding, a receiver peer sends a layer chunk request to the neighbor that can deliver this layer chunk at the earliest time. Therefore, if τ_{n,k} is the minimum, and if it is less than the playback deadline of the layer chunk, then receiver peer n sends the request to peer k. If, on the other hand, this layer chunk cannot meet its playback deadline, it is not requested, and the receiver requests the LC with next higher score (provided it meets the foregoing test).

### § 4.3 EXEMPLARY APPARATUS

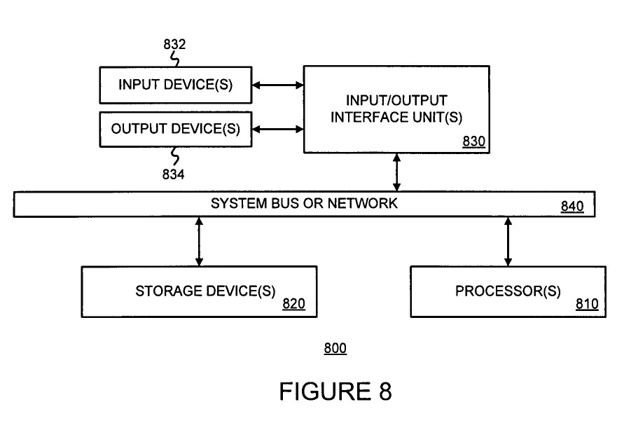

FIG. 8 is a block diagram of exemplary apparatus that may be used to perform operations in a manner consistent with the present invention and/or to store information in a manner consistent with the present invention. The apparatus 800 includes one or more processors 810, one or more input/output interface units 830, one or more storage devices 820, and one or more system buses and/or networks 840 for facilitating the communication of information among the coupled elements. One or more input devices 832 and one or more output devices 834 may be coupled with the one or more input/output interfaces 830.

The one or more processors 810 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. For example, one or more software modules, when executed by a processor, may be used to perform one or more of the operations and/or methods of FIGS. 2-6. At least a portion of the machine executable instructions may be stored (temporarily or more permanently) on the one or more storage devices 820 and/or may be received from an external source via one or more input interface units 830.

In one embodiment, the machine 800 may be one or more conventional personal computers or servers. In this case, the processing units 810 may be one or more microprocessors. The bus 840 may include a system bus. The storage devices 820 may include system memory, such as read only memory (ROM) and/or random access memory (RAM). The storage devices 820 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 832, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 810 through an appropriate interface 830 coupled to the system bus 840. The output devices 834 may include a monitor or other type of display device, which may also be connected to the system bus 840 via an appropriate interface. In addition to (or instead of) the monitor, the personal computer may include other (peripheral) output devices (not shown), such as speakers and printers for example.

The operations of peers, such as those described above, may be performed on one or more computers. Such computers may communicate with each other via one or more networks, such as the Internet for example. Referring back to FIG. 2 for example, the various operations and information may be embodied by one or more machines 810. The peers can be employed in nodes such as desktop computers, laptop computers, personal digital assistants, mobile telephones, other mobile devices, servers, etc. They can even be employed in nodes that might not have a video display screen, such as routers, modems, set top boxes, etc.

Alternatively, or in addition, the various operations and acts described above may be implemented in hardware (e.g., integrated circuits, application specific integrated circuits (ASICs), field programmable gate or logic arrays (FPGAs), etc.).

### § 4.4 REFINEMENTS, ALTERNATIVES AND EXTENSIONS

§ 4.4.1 Alternatives to Layered Coding (and Layer Chunks)

Although the foregoing exemplary embodiments pertained to layered chunks, at least some embodiments consistent with the present invention may be used in the context of substreams (e.g., MD-FEC descriptions), or substream chunks. For example, the '248 provisional describes how some embodiments consistent with the present invention may be used in the context of various other substreams.

§ 4.4.2 Alternative Receiver Peer Scheduling

§ 4.4.2.1 First Alternative Receiver Peer Scheduling

Although the foregoing receiver peer scheduling operation(s) were described in the context of a layer coded video system, the present invention is not limited to such systems. For example, in MDC systems, when requesting Description Chunks (“DCs”), there are two conflicting goals. On one hand, it is desirable to have as many descriptions as possible that can be played out in the near future. On the other hand, it is desirable that there not be a lot of variation in the number of descriptions that are displayed from one description chunk time to the next (so that there is not a lot of variation in the quality of the video). At least some exemplary embodiments consistent with the claimed invention may use the following heuristic for prioritizing the description chunks that are to be requested at the beginning of a round. The heuristic starts at the first description chunk time (scanning from the current time towards the end of the window) that has no buffered or requested description chunks. Assuming there is such a description chunk time, a description chunk is chosen randomly from those that are available.

FIG. 7B shows how description chunks are requested, where the number in each box represents the sequence that the description chunk that is requested. More specifically, the numbers indicate the order in which to request these chunks. For example, the chunk from time index 6 and description 2 is first requested. Since this is MDC, all descriptions are equal (there is no dependency), so the main consideration is how many descriptions are available. Time index 6 has no descriptions available and has the smallest time index (more urgent), so we request it first. In FIG. 7B, the first description chunk time that has no buffered (X) or requested (−) description chunks is the sixth description chunk time. For this description chunk time there are two available description chunks. One of these two description chunks is randomly selected, and it becomes the description chunk that is requested first. After selecting the description chunk, it is possible that more than one neighbor may have this description chunk. The receiver peer sends the request to a neighbor from which the description chunk is expected to be received at the earliest time.

Continuing with the heuristic, since a description chunk is now requested for the sixth time, the first description chunk time with no buffered (X) or requested (−) description chunks will now be the seventh description chunk time. For this description chunk time, there are four available description chunks. One of these four available description chunks is chosen at random. After selecting the description chunk, it is possible that more than one neighbor may have this description chunk. The receiver peer sends the request to a neighbor from which the description chunk is expected to be received at the earliest time.

This heuristic continues until every description chunk time has at least one buffered (X) or requested (−) description chunk, neglecting description chunk times that have no available description chunks (that is, all circles). The heuristic is then continued, giving priority to description chunk times that have exactly one buffered or requested DC. Since with MDC, the video quality improves with an increasing number of descriptions, this heuristic seeks to incrementally obtain more description chunks, once all description chunk time slots have either (a) a buffered description chunk (X), (b) a requested description chunk (−), or (c) no available description chunks (all O's).

A receiver peer n can estimate the time τ_{n,k} that a description chunk is to be received from its neighbor peer k by the following equation:

$${τ}_{n , k} = {t}_{0} + {C}_{n , k} \frac{r Δ}{{d}_{n , k}} , \qquad ( 5 )$$

where t₀ is the current time, C_{n,k} is the number of outstanding requests from n to k, r is the bitrate of one description, and d_{n,k} is the estimated download rate of peer n from peer k. Note that in the foregoing exemplary heuristic, a peer sends a description chunk request to a neighbor that can deliver the requested description chunk at the earliest time. Therefore, if τ_{n,k} is the minimum, and if it is less than this description chunk's playback deadline, then peer n sends the request to peer k. If this description chunk cannot meet its playback deadline, it is not requested, and the heuristic goes to the next description chunk. In FIG. 7B, the “2” with a dash at the seventh description chunk time means that this description chunk should be the second description chunk to be requested with the given buffer state. However, this description chunk cannot meet its playback deadline based on the estimation in Equation (5) for all the neighboring peers of receiver peer n. Thus the receiver peer does not bother sending out a request for this description chunk, but rather selects another description chunk at the seventh description chunk time.

Given the total potential download rate of a peer, which depends on its upload contribution, if a peer requests too aggressively for description chunks with a particular description chunk time and receives a video rate higher than its potential download rate at that time, then this peer is more likely to receive a lower video rate at other times. This leads to a video quality variation at the receiver peer. In this exemplary embodiment consistent with the present invention, to deduce quality variation, a peer k may maintain a threshold Γₖ, which is set to half between the current download rate Dₖ and the potential download rate Uₖ, plus an aggresivity factor α, such that:

$${Γ}_{k} = ⌊ \frac{{D}_{k} + {U}_{k}}{2 r} + α ⌋ \qquad ( 6 )$$

where r is the bitrate of one description. At a given description chunk time, if there are more than γₖ description chunks that have already been buffered or requested, peer k does not request any additional description chunk at that time. When Dₖ is much less than Uₖ, Dₖ is more likely to increase, or has more room to increase. Thus the peer requests more aggressively. After receiving the requested description chunks, a receiver peer with a high Uₖ can potentially contribute more to its neighbors. In turn, this improves the probability that this peer can be served by its neighbors. Therefore, it leads to an increased download bitrate for peer k.

The fast-start phase accelerates the convergence process from a lower Dₖ to the target receiving rate Dₖ=Uₖ. When Dₖ reaches Uₖ, a peer requests

$$⌊ \frac{{U}_{k}}{r} + α ⌋$$

descriptions, which is comparable to its uplink bandwidth contribution. This is a bandwidth probing procedure. (Note that this procedure is note used in the double-queue approach described in § 4.4.3.

As shown in FIG. 7B, where Γₖ=3, there are at most 3 description chunks that have been buffered or requested for each description chunk time, no matter how many description chunks are available at that description chunk time.

§ 4.4.2.2 Second Alternative Receiver Peer Scheduling

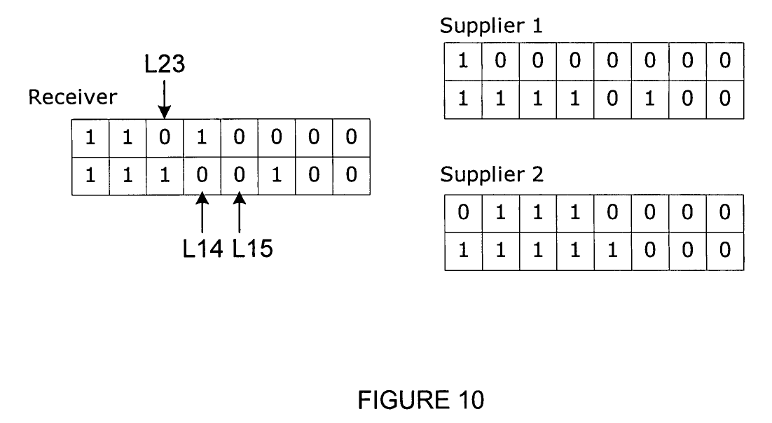

In at least some embodiments consistent with the claimed invention, as a receiver, each peer may adopt a random request algorithm to request the LCs from its neighbors. FIG. 10 illustrates an example illustrating how the exemplary random request technique operates. In this example, the video is encoded into two layers—layer 1 and layer 2. Each peer will buffer at most eight LCs from each layer. Lij indicates that this chunk is the jth LC from layer i. In the buffer map, “1” indicates this LC is available in this peers' buffer, while “0” indicates this LC is unavailable. After exchanging buffer maps, the receiver knows that there are three LCs (L14, L15 and L23) that are unavailable in its buffer but available from its suppliers 1 and 2. Since LC L23 is only available at supplier 2, the receiver requests this LC from supplier 2. Similarly, the receiver requests L15 from supplier 2. For L14, both supplier 1 and supplier 2 have this LC.

Ties can be handled many ways. One possibility is for the receiver to randomly select a supplier for this LC. The receiver performs the above receiver side scheduling algorithm periodically, based on the most recent buffer maps from its suppliers.

Each request has a deadline T. If within time T (after the request has been sent) the LC has not been received, the receiver assumes that this LC cannot be served on time and requests it again based on the same algorithm in the next request period. In the supplier side, if the supplier cannot serve a request within time T after it has received this request, it will automatically remove this request from its request queue.

§ 4.4.3 Download Rate Probing

In the exemplary receiver-side scheduling described above, peer n schedules requests to peer k based on the current estimated d_{n,k}. In particular, a layer chunk (or description chunk, or substream chunk) that is expected to arrive after its deadline is not requested. However, d_{n,k} may not match the potential rate that peer n can receive from peer k. If a receiver requests too conservatively, it may not fully utilize the potential bandwidth that its supplier peer has available to allocate to it. On the other hand, if this receiver requests too aggressively, many of its requested layer chunks (or description chunks, or substream chunks) might not be served before their deadlines. In this case, the layer chunk (or description chunk, or substream chunk) requests in a later request round may be blocked by the earlier requests, no matter what their priorities are. An exemplary refinement over the foregoing supplier/receiver scheduling methods is now described.

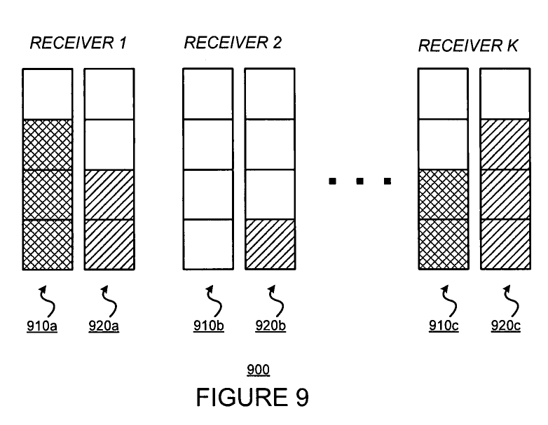

With embodiments using this exemplary alternative scheduling, in addition to sending the regular requests based on the receiver-side scheduling described above, each receiver peer also sends some probing requests to its neighbors. A probing request has lower priority to be served than a regular request. As shown in FIG. 9, in addition to maintaining one request queue 910 as described above, a supplier peer maintains another request queue 920 (referred to as a probing request queue) for each receiver.

In both of these queues 910/920, the requests are served in a FIFO manner. For each receiver, the requests in the probing requests queue 920 can be served only if the regular requests queue 910 is empty. Therefore, if receiver 2 in FIG. 9 is selected for service, the requests in the probing requests queue 920 are served. More specifically, since there is no regular request in the regular request queue for receiver 2, the supplier starts to serve the request in its probing queue. Note that the regular requests are scheduled based on the current estimated download rate d_{n,k}. For receiver peer n, if the potential rate is higher than d_{n,k}, supplier peer k serves the probing requests of receiver peer n after finishing serving all the regular requests, so that the potential upload bandwidth of supplier peer k is probed. If the potential rate is less than d_{n,k}, the probing requests will not be served, but they do not block the regular requests. The supplier peer discards any request that exceeds the deadline of that receiver peer.

In some embodiments consistent with the present invention, these probing requests can be piggybacked in the message of sending regular requests such that the probing requests do not introduce much additional overhead.

§ 4.4.4 Partner Selection

In order to locate a better partner with higher uplink bandwidth and more content, in at least some embodiments consistent with the present invention, a peer periodically replaces the partner with the least contribution with a new peer. To establish a stable relationship, it is desirable for the peer to locate a partner with similar uplink bandwidth. If the uplink bandwidth of the supplying partner is too low, the receiving peer can only receive the lowest layers from the partner. Thus, this supplying partner may not hold the receiving peer's missing layers. If, on the other hand, the uplink bandwidth of the supplying partner is too high, it is likely that other neighbors of the supplying partner have higher uplink bandwidth, so that the receiving peer is dropped by the supplying partner after several rounds.

To locate a suitable partner, one simple approach is to randomly select a peer from the active peers in the system. To accelerate this process, a peer can select a partner from a pre-screened set of candidates. For example, a peer can choose a partner with the same ISP or with the same type of access. These peers are expected to have similar uplink bandwidth. Another approach to locate a candidate is based on peer's buffer maps. (See, e.g., X. Hei and Y. Liu and K.W. Ross, “Inferring network-wide quality in P2P live streaming systems,” submitted.) In such an embodiment, when two peers intend to establish partnership, they exchange their buffer maps before establishing partnership. Since a peer with high contribution is supposed to receive more layers, and vice-versa, the uplink bandwidth contribution of a peer can be evaluated based on its buffer map.

### § 4.5 CONCLUSIONS

Embodiments consistent with the present invention can provide incentives to encourage peers to increase their upload rates, thereby increasing the aggregate upload rate of the P2P system. In particular, the incentive scheme strongly penalizes free-riding. If multi-stream coding is used, the video quality received by the peers can be adapted to the upload capacity of the system. If multi-stream coding is used, initial playback delay can be decreased. Specifically, when a peer starts to view a video, it can choose to receive only one substream instead of the entire streams, which can reduce the initial playback delay significantly. If single-layer coding is used, if the received rate is less than the video bit rate, there is severe video quality degradation. Specifically, as described in the '248 provisional, due to long-term bandwidth fluctuation, the system cannot support all peers. Thus, some peers will experience the severe video quality degradation. With substream trading, weak peers are “selected” to experience video degradation, while strong peers have no video degradation. The received video quality is robust to peer departures. With at least some embodiments consistent with the present invention, a peer's received rate is commensurate with its upload rate, no matter how many peers are in the system.

What is claimed is:

1. A computer-implemented method for serving substream video information from a supplying peer to at least two receiving peers, the computer-implemented method comprising:
a) measuring a rate at which each of the at least two receiving peers have supplied substream video information to the supplying peer; and
b) controlling transmission of substream video information to the at least two receiving peers using at least the download rates measured such that differentiated video quality is provided to the at least two receiving peers.

2. The computer-implemented method of claim 1 wherein the substream video information includes video coded into layers with nested dependency.

3. The computer-implemented method of claim 1 wherein the substream video information includes multiple-description coded video.

4. The computer-implemented method of claim 1 wherein the substream video information includes a plurality of temporal chunks.

5. A computer-implemented method for supplying substream video information which, when decoded, provides video of a quality commensurate with a number of substreams received, the computer-implemented method comprising:
a) obtaining, by a first peer, a list of other peers currently receiving a video;
b) communicating, between the first peer and the other peers, video substream chunk availability information;
c) communicating, between the first peer and the other peers, video substream chunks during a discovery time period;
d) determining, by each of the peers, a rate at which video substream chunks is provided from other peers; and
e) controlling, by one of the other peers, the further transmission of video substream chunks to the first peer using the determined rate at which the first peer has provided video substream chunks to the one of the other peers.

6. The computer-implemented method of claim 5 wherein video substream chunks are one of (A) temporal chunks of layer encoded video, and (B) temporal chunks of multiple description encoded video.

7. The computer-implemented method of claim 5 wherein the act of controlling, by the one of the other peers, the further transmission of video substream chunks to the first peer uses a scheduling procedure including:
i) maintaining a request queue for each of a plurality of receiving peers, the plurality of receiving peers including the first peer,
ii) determining which of the plurality of receiving peers should be served, such that one of the plurality of receiving peers that uploads more substream chunks to the one of the other peers than other of the plurality of receiving peers is served more than the other of the plurality of receiving peers.

8. The computer-implemented method of claim 5 further comprising:
f) buffering, by the first peer, substream chunks to be decoded and rendered; and
g) scheduling the request of substream chunks for a time period by
i) scoring needed substream chunks, and
ii) determining a peer from which to request the scored substream chunks.

9. The computer-implemented method of claim 8 wherein the act of scoring needed substream chunks accounts for at least one of (A) a layer-level index of the substream chunk, (B) a playback deadline of the substream chunk by the first peer, and (C) a rarity of the substream chunk among the other peers.

10. The computer-implemented method of claim 9 wherein a lower layer substream chunk has a higher scheduling priority than a higher layer substream chunk.

11. The computer-implemented method of claim 9 wherein a substream chunk having a nearer playback deadline has a higher scheduling priority than a substream chunk with a later playback deadline.

12. The computer-implemented method of claim 9 wherein a rarer substream chunk has a higher scheduling priority than a more common substream chunk.

13. Apparatus comprising:
a) at least one processor; and
b) at least one storage device storing program instructions which, when executed by the at least one processor, perform a method for serving substream video information from a supplying peer to at least two receiving peers, the method including
1) measuring a rate at which each of the at least two receiving peers have supplied substream video information to the supplying peer, and
2) controlling transmission of substream video information to the at least two receiving peers using at least the download rates measured such that differentiated video quality is provided to the at least two receiving peers.

14. The apparatus of claim 13 wherein the substream video information includes video coded into layers with nested dependency.

15. The apparatus of claim 13 wherein the substream video information includes multiple-description coded video.

16. Apparatus comprising:
a) at least one processor; and
b) at least one storage device storing program instructions which, when executed by the at least one processor, perform a method for supplying substream video information which, when decoded, provides video of a quality commensurate with a number of substreams received, the method including
1) obtaining, by a first peer, a list of other peers currently receiving a video,
2) communicating, between the first peer and the other peers, video substream chunk availability information,
3) communicating, between the first peer and the other peers, video substream chunks during a discovery time period,
4) determining, by each of the peers, a rate at which video substream chunks is provided from other peers, and
5) controlling, by one of the other peers, the further transmission of video substream chunks to the first peer using the determined rate at which the first peer has provided video substream chunks to the one of the other peers.

17. The apparatus of claim 16 wherein video substream chunks are one of (A) temporal chunks of layer encoded video, and (B) temporal chunks of multiple description encoded video.

18. The apparatus of claim 16 wherein in the method, the act of controlling, by the one of the other peers, the further transmission of video substream chunks to the first peer uses a scheduling procedure including:
A) maintaining a request queue for each of a plurality of receiving peers, the plurality of receiving peers including the first peer,
B) determining which of the plurality of receiving peers should be served, such that one of the plurality of receiving peers that uploads more substream chunks to the one of the other peers than other of the plurality of receiving peers is served more than the other of the plurality of receiving peers.

19. The apparatus of claim 16 wherein the method further includes
6) buffering, by the first peer, substream chunks to be decoded and rendered, and
7) scheduling the request of substream chunks for a time period by
A) scoring needed substream chunks, and
B) determining a peer from which to request the scored substream chunks.

20. The apparatus of claim 19 wherein in the method, the act of scoring needed substream chunks accounts for at least one of (A) a layer-level index of the substream chunk, (B) a playback deadline of the substream chunk by the first peer, and (C) a rarity of the substream chunk among the other peers.
